(19) United States
(12) Patent Application Publication
(10) Pub. No.: US 2008/0112326 A1
(43) Pub. Date: May 15, 2008

(54) Load-Balancing Routes In Multi-Hop Ad-Hoc Wireless Networks

(75) Inventors: Anjur Sundaresan Krishnakumar, Rocky Hill, NJ (US); P. Krishnan, North Plainfield, NJ (US); Shalini Yajnik, Berkeley Heights, NJ (US); Sameh Gobriel, Pittsburgh, PA (US)

Correspondence Address: DEMONT & BREYER, LLC, 100 COMMONS WAY, STE 250, HOLMDEL, NJ, 07733, US

(73) Assignee: AVAYA TECHNOLOGY LLC, Basking Ridge, NJ (US)

(21) Appl. No.: 11/937,911

(22) Filed: Nov. 9, 2007

Related U.S. Application Data
(60) Provisional application No. 60/865,132, filed on Nov. 9, 2006.

(51) Int. Cl. G08C 15/00

(52) U.S. Cl. 370/238

(57) ABSTRACT

An apparatus and methods are disclosed that enable load-balancing of routes in ad-hoc wireless networks. In accordance with the illustrative embodiment, when a candidate intermediate node receives a routing-protocol message, the node waits before it transmits a message in response to the received message, where the amount of time that the node waits is based on the value of a load metric at the node and is independent of any other nodes in the network. As a result, a node that has a larger load will wait longer to transmit its routing-protocol message, and consequently, it is less likely that this node will be selected for inclusion in the new route. The techniques of the illustrative embodiment are applicable to both proactive and on-demand routing protocols, and are also applicable to other kinds of networks.

### CROSS-REFERENCE TO RELATED APPLICATIONS

This application claims the benefit of U.S. provisional application Ser. No. 60/865,132, filed Nov. 9, 2006, entitled “Multi-Hop Ad-Hoc Wireless IP Telephony,” (Attorney Docket: 630-267us), which is also incorporated by reference.

### FIELD OF THE INVENTION

The present invention relates to telecommunications in general, and, more particularly, to multi-hop ad-hoc wireless networks.

### BACKGROUND OF THE INVENTION

In a wireless ad-hoc network, nodes (e.g., wireless telecommunications terminals, etc.) communicate with each other via a mesh topology without a central access point or server. The term ad-hoc reflects the fact that nodes can form networks “on the fly” without any supporting networking infrastructure, as well as the fact that the mobility of nodes can result in frequent changes in network membership and topology.

FIG. 1 depicts the salient elements of illustrative ad-hoc wireless network 100 in accordance with the prior art. As shown in FIG. 1, wireless network 100 comprises nodes 101-1 through 101-8; these nodes are capable of transmitting and receiving messages in point-to-point fashion via wireless communication links, which are depicted in FIG. 1 by “lightning bolts.”

Typically nodes 101-1 through 101-8 communicate via any of a variety of wireless communications protocols, such as one of the Institute of Electrical and Electronics Engineers (IEEE) 802.11 family of protocols in ad-hoc mode (as opposed to the more-common infrastructure mode), the Bluetooth short-range wireless protocol, etc. When nodes 101-1 through 101-8 are capable of transmitting and receiving messages via a path comprising two or more wireless communication links (or “hops”), network 100 is said to be a multi-hop ad-hoc wireless network. In a multi-hop ad-hoc wireless network, a routing protocol guides the delivery of messages throughout the network.

Routing protocols can generally be classified into two categories: proactive, and reactive. Proactive routing protocols, such as Destination-Sequenced Distance-Vector (DSDV) routing, try to maintain correct routing information at all nodes in the network at all times. Proactive protocols are typically table-driven, with topology changes handled through periodic broadcast of routing table updates.

In contrast, reactive (or on-demand) routing protocols, such as Ad-hoc On-Demand Distance Vector (AODV) routing, Optimized Link State Routing (OLSR), and Dynamic Source Routing (DSR), obtain a route only when needed. Reactive routing protocols typically can support rapid rates of node mobility and frequent topology changes, but suffer from a larger route-setup overhead than proactive routing protocols. Proactive routing protocols, meanwhile, are either slow to respond to dynamism in the network, or require significant bandwidth overhead to maintain up-to-date routes.

Nodes along a route from a source node to a destination node are referred to as intermediate nodes. When a node serves as an intermediate node on a given route, this can place demands on the input/output and processing resources of the node. It is therefore advantageous if a routing protocol establishes routes in accordance with a load-balancing strategy that attempts to spread these demands evenly among various nodes in the network, rather than concentrating these demands on a small number of nodes.

Some load-balancing routing protocols use a load metric to estimate the loads at individual nodes, and then compute the overall load of a route via a “load-combining function” (e.g., a summation of the loads of the nodes in the route, the maximum load in a route, etc.). Some examples of load metrics include: the number of routes to which a node currently belongs; the average depth of a node's transmission buffer (i.e., how many packets on average are queued for transmission at the node); and so forth.

### SUMMARY OF THE INVENTION

The present invention provides a novel heuristic with which routing protocols can load-balance routes. In particular, in accordance with the illustrative embodiment, when a candidate intermediate node receives a routing-protocol message, the node waits before it transmits a message in response to the received message, where the amount of time that the node waits is based on the value of a load metric at the node, and is independent of any other node in the network. As a result, a node that has a larger load will wait longer to transmit its routing-protocol message, and consequently, it is less likely that this node will be selected for inclusion in the new route. The illustrative embodiment can thus provide good (albeit sub-optimal) route load-balancing with relatively low overhead (i.e., with much fewer routing-protocol messages than a full-blown “naïve” approach where all the nodes transmit all the routing-protocol messages.)

In accordance with the illustrative embodiment, a load metric might be based on, for example, any combination of:
the number of current routes in the network that include the node;
the depth of a node's transmission buffer over a time interval (e.g., average depth, maximum depth, etc.);
an estimate of the processing capacity available at a node (derived, perhaps, from CPU utilization);
an estimate of the processing requirements for the node to participate in a new route from the source node to the destination node;
an estimate of the input/output capacity available at a node; and
an estimate of the input/output requirements for the node to participate in a new route from the source node to the destination node.

The load metric at a node is thus based solely on properties of that node, and not on properties of other nodes in the network (e.g., the loads at other nodes, the physical locations of other nodes, etc.), or of communication links in the network (e.g., noise on a particular link, etc.).

The illustrative embodiment is disclosed in the context of on-demand routing in wireless multicast ad-hoc networks. However, the techniques of the illustrative embodiment might be employed for proactive routing protocols, or for other kinds of networks, such as: networks that do not support multicasting; wireless local-area networks that are not ad-hoc in nature (e.g., IEEE 802.11 networks in infrastructure node, etc.); wired local-area networks (e.g., Ethernet, etc.); metropolitan-area networks; wide-area networks, etc.

The illustrative embodiment comprises: receiving at a first node in a network a first message that is for establishing a route in the network; and transmitting from the first node, after a first delay following the reception of the first message, a second message that is for establishing a route in the network that includes the first node; wherein the delay is based on the value of a load metric at the first node.

### BRIEF DESCRIPTION OF THE DRAWINGS

FIG. 1 depicts the salient elements of illustrative ad-hoc wireless network 100, in accordance with the prior art.

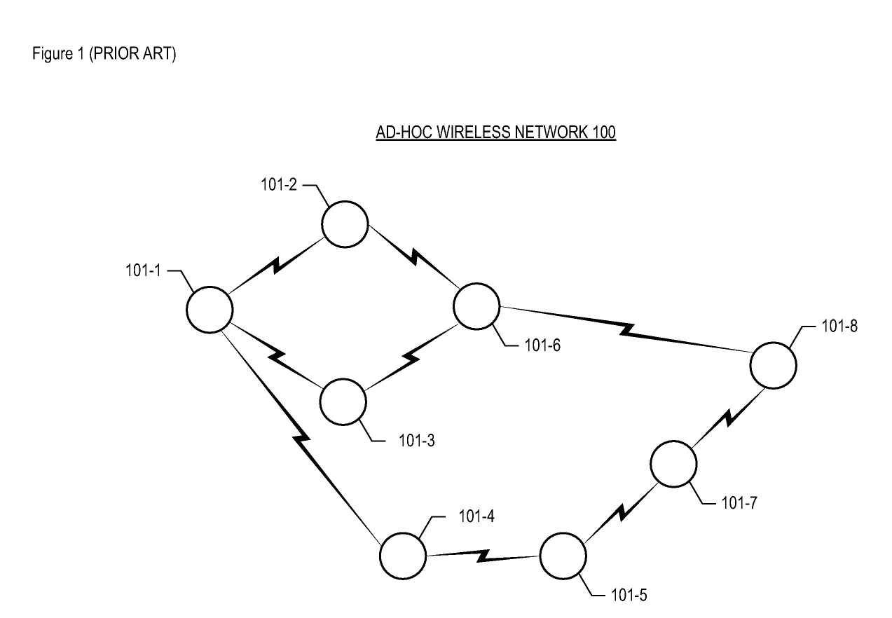

FIG. 2 depicts the salient elements of ad-hoc wireless network 200, in accordance with the illustrative embodiment of the present invention.

FIG. 3 depicts the propagation of a route request through ad-hoc wireless network 200, as depicted in FIG. 2, when node 201-1 has a message to transmit to node 201-8, in accordance with the illustrative embodiment of the present invention.

FIG. 4 depicts the transmission of a route reply from node 201-8 to node 201-1, in accordance with the illustrative embodiment of the present invention.

FIG. 5 depicts a flowchart of the salient tasks performed by a source node 201-i in establishing a route to a destination node 201-j, in accordance with the illustrative embodiment of the present invention.

FIG. 6 depicts a flowchart of the salient tasks performed by an intermediate node 201-k during the establishment of a route from source node 201-i to destination node 201-j, in accordance with the illustrative embodiment of the present invention.

FIG. 7 depicts a detailed flowchart of task 680, as depicted in FIG. 6, in accordance with the illustrative embodiment of the present invention.

FIG. 8 depicts a flowchart of the salient tasks performed by destination node 201-j in establishing a route from source node 201-i to node 201-j, in accordance with the illustrative embodiment of the present invention.

FIG. 9 depicts a flowchart of the salient tasks performed by destination node 201-j when a timer set in the method of FIG. 8 expires, in accordance with the illustrative embodiment of the present invention.

### DETAILED DESCRIPTION

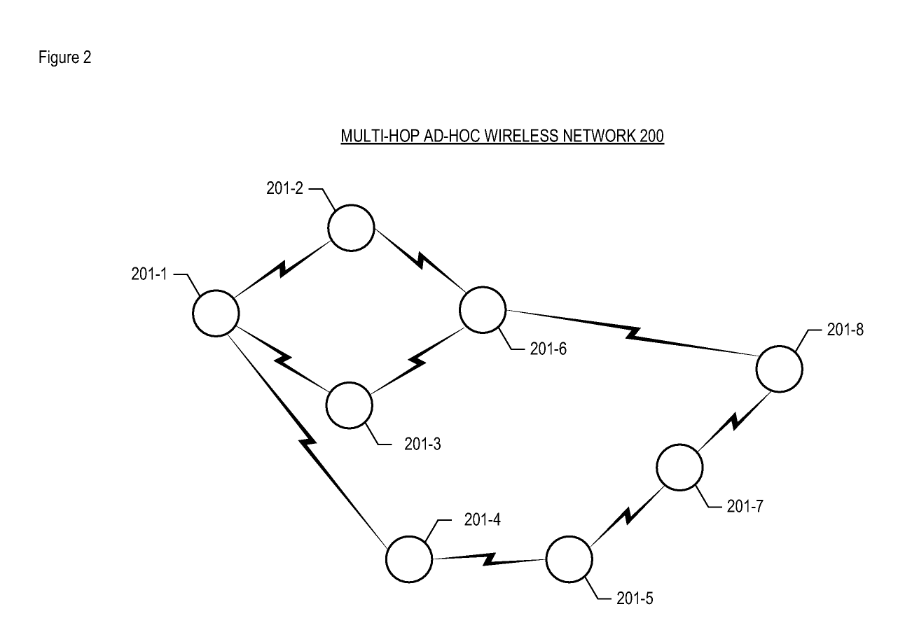

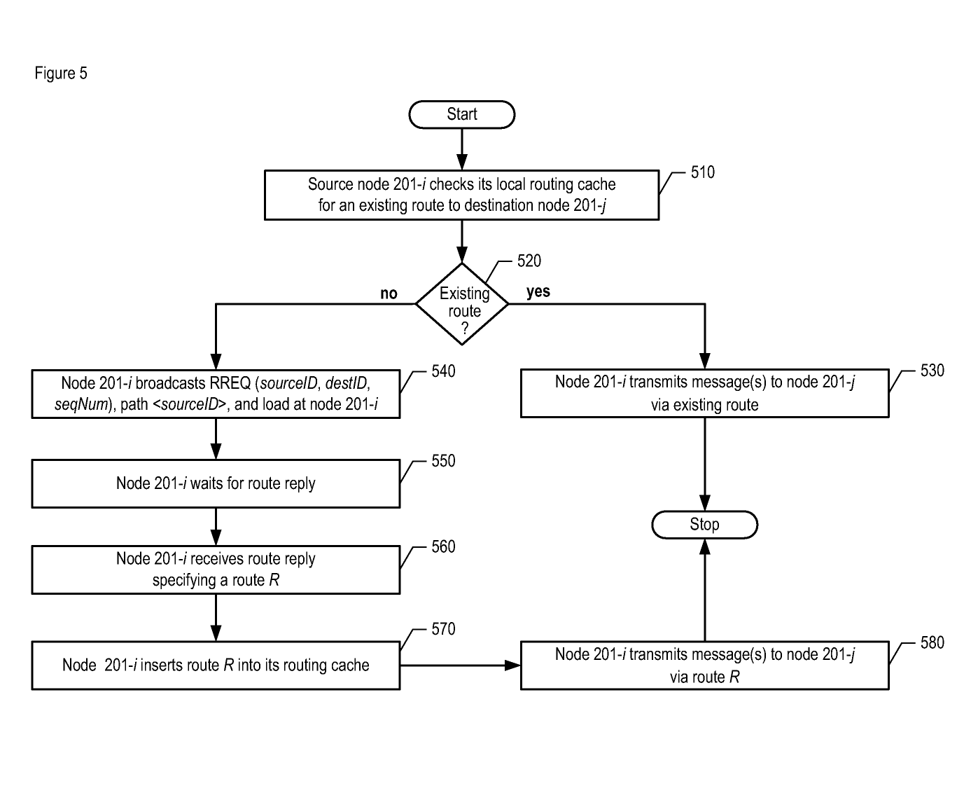

FIG. 2 depicts the salient elements of ad-hoc wireless network 200 in accordance with the illustrative embodiment of the present invention. As shown in FIG. 2, wireless network 200 comprises nodes 201-1 through 201-8, with wireless communication links between these elements indicated by “lightning bolts.” Each of nodes 201-1 through 201-8 is capable of transmitting and receiving messages in point-to-point fashion via the wireless communication links of network 200, of participating as an intermediate node in a multi-hop route through ad-hoc wireless network 200, and of transmitting messages in a multicast (i.e., point-to-multipoint) mode, as is well-known in the art. Moreover, as is described below and with respect to FIGS. 5 through 7, each of nodes 201-1 through 201-8 is capable of maintaining: a routing cache, a list of route requests recently received by the node, and the best (e.g., lowest, etc.) load metric value encountered for each route request.

In accordance with the illustrative embodiment, on-demand routing is employed when a source node has a message to transmit to a destination node. In particular, a route is established by the following procedure: first, a route request (RREQ) is initiated by the source node and is propagated through ad-hoc wireless network 200 to the destination node; then, a route reply is initiated by the destination node and is propagated back through ad-hoc wireless network 200 to the source node.

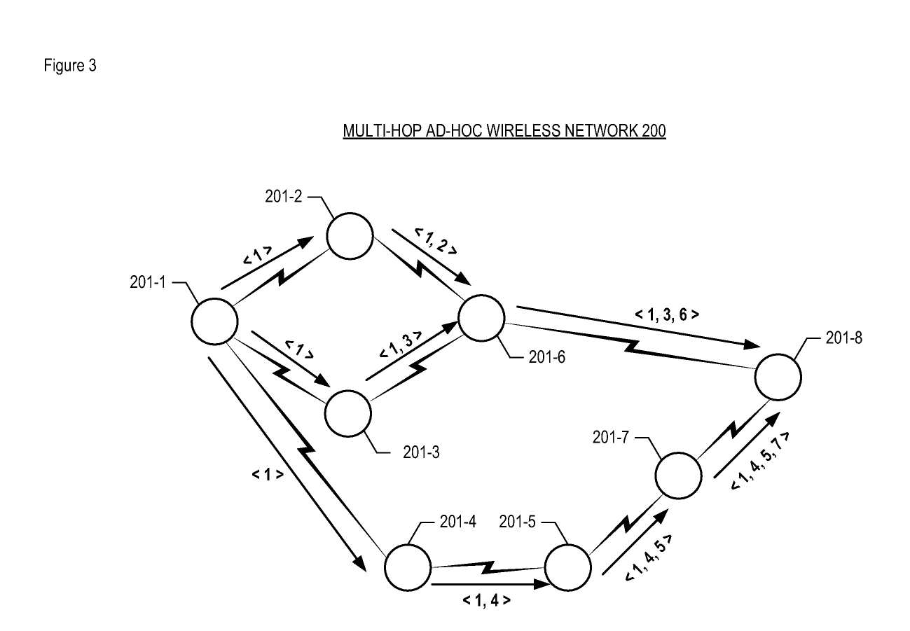

FIG. 3 depicts the propagation of a route request (RREQ) through ad-hoc wireless network 200 from source node 201-1 to destination node 201-8, in accordance with the illustrative embodiment of the present invention. In FIG. 3, the arrows indicate the direction in which the route request is transmitted between nodes, and the arrow labels indicate the route description that is transmitted along with the route request. For example, the labeled arrow from node 201-5 to node 201-7 indicates that node 201-5 transmits the partial route <201-1, 201-4, 201-5> to node 201-7 along with the route request. (FIG. 3 omits the “201-” portion of the route descriptions for brevity.) The exact mechanism by which the route request and associated information are propagated through ad-hoc wireless network 200 is described in detail below and with respect to FIGS. 5 through 7.

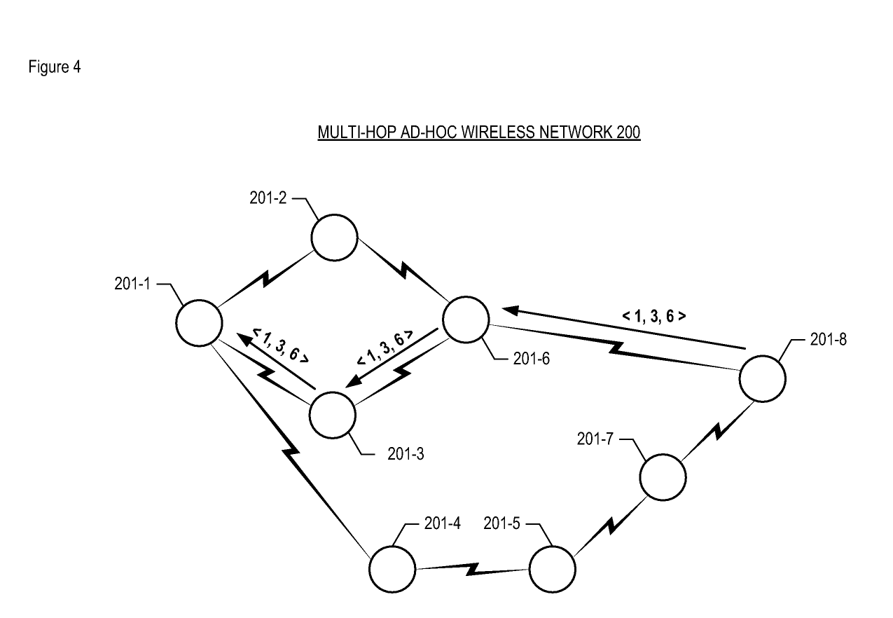

After the route request is received at destination node 201-8, a route reply is transmitted by destination 201-8 back to source node 201-1 along a route that is determined by destination node 201-8; the exact mechanism of this determination and transmission is described below and with respect to FIGS. 5 through 7. An illustrative transmission of a route reply from destination node 201-8 to source node 201-1 is shown in FIG. 4.

FIG. 5 depicts a flowchart of the salient tasks performed by a source node 201-i in establishing a route to a destination node 201-j, in accordance with the illustrative embodiment of the present invention. It will be clear to those skilled in the art, after reading this disclosure, which tasks depicted in FIG. 5 can be performed simultaneously or in a different order than that depicted.

At task 510, if caching is enabled, source node 201-i checks its local routing cache for an existing route to destination node 201-j, in well-known fashion.

At task 520, execution branches based on whether an existing route was found in the routing cache at step 510. If so, execution proceeds to task 530, otherwise execution continues at task 540.

At task 530, source node 201-i transmits one or more messages to destination node 201-j via the existing route, in well-known fashion. After task 530 is performed, the method of FIG. 5 terminates.

At task 540, source node 201-i broadcasts a route request (RREQ) of the form (sourceID, destID, seqNum), where sourceID identifies the source node (node 201-1 in illustrative network 200), destID identifies the destination node (node 201-8 in network 200), and seqNum is a source-initiated sequence number that enables nodes to detect when they receive duplicate route requests. Source node 201-i also broadcasts, along with the route request, single-node path <sourceID>, and the value of the selected load metric at node 201-i (typically zero). The route request and accompanying information is received by all nodes within the wireless transmission range of node 201-i (in the case of illustrative network 200, the route request is broadcast by node 201-1 and is received by nodes 201-2, 201-3, and 201-4).

At task 550, source node 201-i waits for a route reply, in well-known fashion.

At task 560, source node 201-i receives a route reply that specifies a route R, in well-known fashion.

At task 570, source node 201-i inserts route R into its routing cache. (The routing cache might have been invalidated as a result of a timeout or the receipt of a route-error message.)

At task 580, source node 201-i transmits one or more messages to destination node 201-j via route R, in well-known fashion. After task 580 is performed, the method of FIG. 5 terminates.

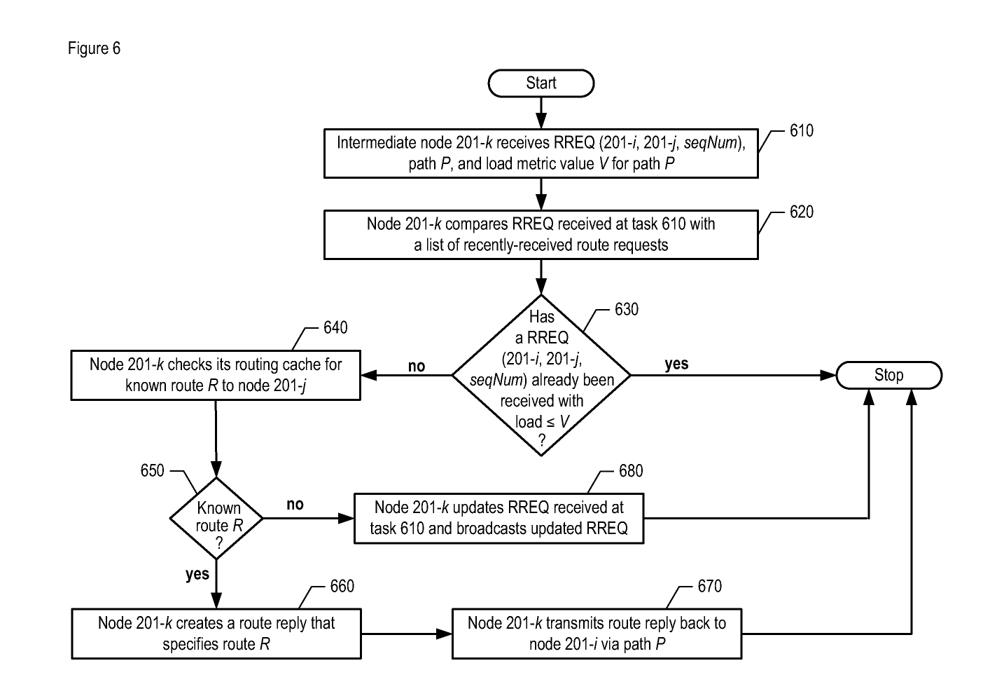

FIG. 6 depicts a flowchart of the salient tasks performed by an intermediate node 201-k during the establishment of a route from source node 201-i to destination node 201-j, in accordance with the illustrative embodiment of the present invention. It will be clear to those skilled in the art, after reading this disclosure, which tasks depicted in FIG. 6 can be performed simultaneously or in a different order than that depicted.

At task 610, intermediate node 201-k receives a route request [RREQ] (201-i, 201-j, seqNum), a path P, and a load metric value V for path P.

At task 620, intermediate node 201-k compares the RREQ received at task 610 with its list of recently-received route requests.

At task 630, execution branches based on whether intermediate node 201-k has already been received a route request (201-i, 201-j, seqNum) with an accompanying load metric value no larger than V. If so, the method of FIG. 6 terminates, otherwise execution proceeds to task 640.

At task 640, if caching is enabled, intermediate node 201-k checks its routing cache for a known route R to destination node 201-j.

At task 650, execution branches based on whether a known route R was found at task 640. If so, execution proceeds to task 660, otherwise execution continues at task 680.

At task 660, intermediate node 201-k creates a route reply that specifies route R.

At task 670, intermediate node 201-k transmits the route reply back to source node 201-i via path P. After task 670, the method of FIG. 6 terminates.

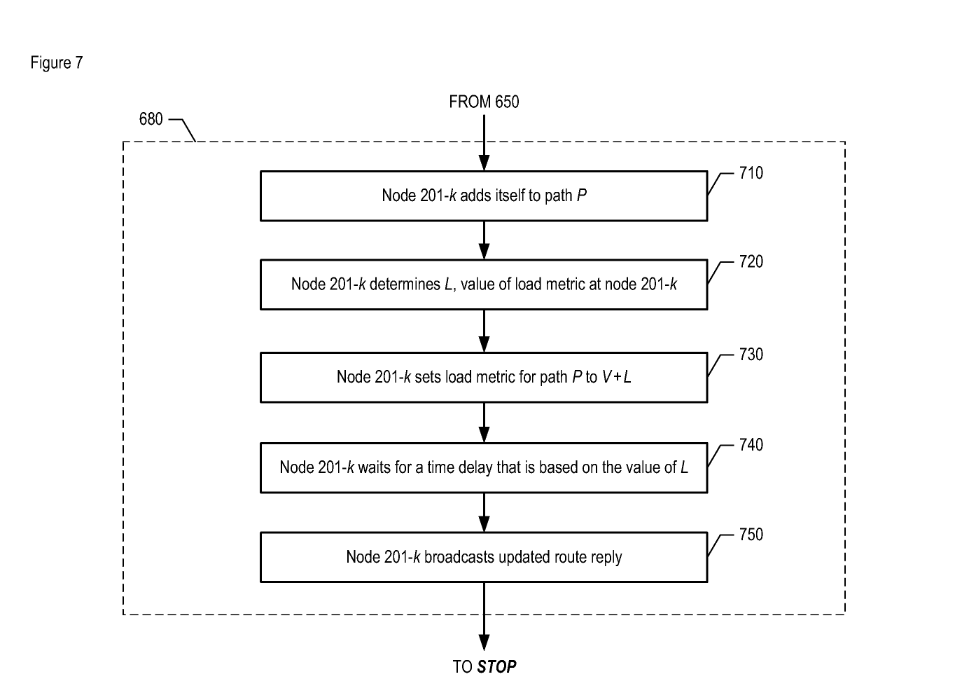

At task 680, intermediate node 201-k updates the route request received at task 610 and broadcasts the updated RREQ. Task 680 is described in detail below and with respect to FIG. 7. After task 680, the method of FIG. 6 terminates.

FIG. 7 depicts a detailed flowchart of task 680 in accordance with the illustrative embodiment of the present invention. It will be clear to those skilled in the art, after reading this disclosure, which tasks depicted in FIG. 7 can be performed simultaneously or in a different order than that depicted.

At task 710, intermediate node 201-k adds itself to path P.

At task 720, intermediate node 201-k determines L, the value of the load metric at node 201-k.

At task 730, intermediate node 201-k sets the value of the load metric for path P to V+L. As will be appreciated by those skilled in the art, although in the illustrative embodiment the load of a route is simply the sum of the loads of the nodes along the route, in some other embodiments of the present invention the load of a route might be defined differently (e.g., the maximum load along a route, some other non-linear function of the nodes' loads, etc.), and it will be clear to those skilled in the art, after reading this disclosure, how to modify task 730 accordingly to support the desired route load function.

At task 740, intermediate node 201-k waits for a time delay whose length is based on the value of L. As explained above, this essentially “penalizes” intermediate nodes with larger loads and therefore has the effect of load-balancing routes among the nodes in network 200.

At task 750, intermediate node 201-k broadcasts the updated route reply, in well-known fashion. After task 750, task 680 is completed, and the method of FIG. 6 terminates.

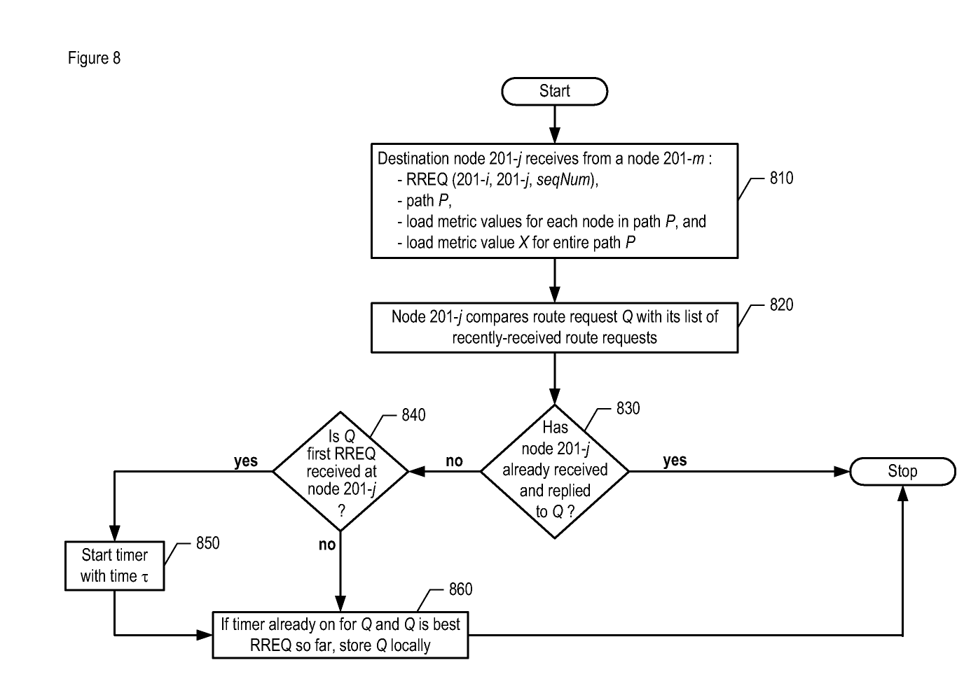

FIG. 8 depicts a flowchart of the salient tasks performed by destination node 201-j in establishing a route from source node 201-i to node 201-j, in accordance with the illustrative embodiment of the present invention. It will be clear to those skilled in the art, after reading this disclosure, which tasks depicted in FIG. 8 can be performed simultaneously or in a different order than that depicted.

At task 810, destination node 201-j receives a route request (RREQ) Q, a path P, and a load metric value V for path P.

At task 820, destination node 201-j compares route request Q with its list of recently-received route requests.

At task 830, execution branches based on whether destination node 201-j already received and replied to route request Q. If so, execution of the method terminates, otherwise execution continues at task 840.

At task 840, execution branches based on whether route request Q is the first route request received at destination node 201-j. If so, execution proceeds to task 850, otherwise execution continues at task 860.

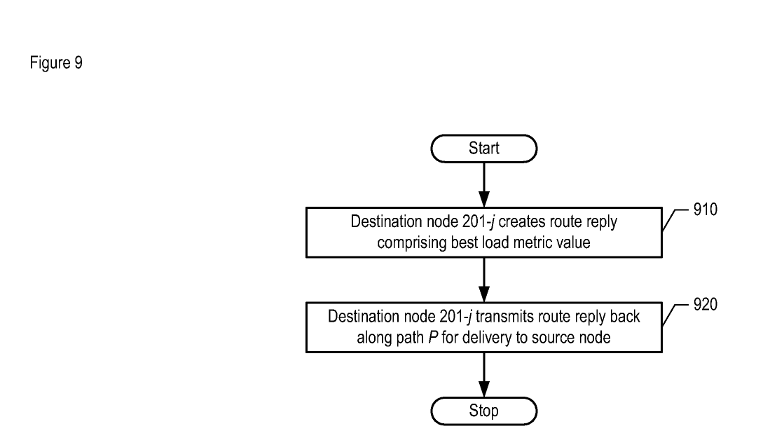

At task 850, destination node 201-j starts a timer with time τ. During this time interval of length τ, destination node 201-j collects all incoming requests. When the timer expires, the destination selects the best route and includes it in the generated route reply, as described below and with respect to FIG. 9.

As will be appreciated by those skilled in the art, there is a tradeoff in determining timeout value σ: it should be long enough to collect all the route requests, but at the same time it shouldn't increase the overall end-to-end delay or cause source node 201-i to timeout and send a new request. In the illustrative embodiment, the value of [symbol] is proportional to the propagation time of the first request from source node 201-i to destination node 201-j, where the particular proportionality constant is based on the value of the route request (RREQ) timeout. This results in a value of [symbol] that accounts for how congested the network is, while maintaining independence from path length.

As will be appreciated by those skilled in the art, in some other embodiments of the present invention, the value of τ might be chosen or determined in some other way (e.g., based on empirical observations, based on simulation results, etc.).

At task 860, destination node 201-j checks whether a timer is already on for route request Q and if it is, destination node 201-j stores Q locally if it is the best route request received so far. After task 860, the method of FIG. 8 terminates.

FIG. 9 depicts a flowchart of the salient tasks performed by destination node 201-j when the timer set in the method of FIG. 8 expires, in accordance with the illustrative embodiment of the present invention. It will be clear to those skilled in the art, after reading this disclosure, which tasks depicted in FIG. 9 can be performed simultaneously or in a different order than that depicted.

At task 910, destination node 201-j creates a route reply comprising the best (e.g., lowest, etc.) load metric value encountered at the node.

At task 920, destination node 201-j transmits the route reply back along path P for delivery to source node 201-i. After task 920, the method of FIG. 9 terminates.

As will be appreciated by those skilled in the art, the methods of FIGS. 8 and 9 employ a strategy in which destination node 201-j replies with the best metric seen so far after the timer has expired. As will be appreciated by those skilled in the art, some other embodiments of the present invention might employ alternative strategies, and it will be clear to those skilled in the art, after reading this disclosure, how to make and use such embodiments.

As will be appreciated by those skilled in the art, although the illustrative embodiment of the present invention is disclosed in the context of multi-hop ad-hoc wireless networks, some or all of the techniques of the illustrative embodiment might also be employed in other kinds of networks. Similarly, although the illustrative embodiment of the present invention is disclosed in the context of on-demand routing, some or all of the techniques of the illustrative embodiment might also be employed in networks that use proactive routing.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving at a first node in a network a first message that is for establishing a route in said network; and
transmitting from said first node, after a first delay following the reception of said first message, a second message that is for establishing a route in said network that includes said first node;
wherein said delay is based on the value of a load metric at said first node and is independent of any other nodes in said network.

2. The method of claim 1 wherein said network is an ad-hoc wireless network.

3. The method of claim 1 wherein said second message is a multicast message.

4. The method of claim 1 wherein said first message is a multicast message, said method further comprising:
receiving said first message at a second node in said network; and
transmitting from said second node, after a second delay following the reception of said first message, a third message that is for establishing a route in said network that includes said second node;
wherein said second delay is based on the value of said load metric at said second node and is independent of any other nodes in said network.

5. The method of claim 4 further comprising adding one of said first node and said second node to an existing route based on which of said second message and said third message is received first at a third node in said network.

6. The method of claim 1 wherein said load metric for a node is based on the depth of a transmission buffer at said node over a time interval.

7. The method of claim 1 wherein said load metric for a node is based on the number of current routes in said network that include said node.

8. The method of claim 1 wherein said load metric for a node is based on the processing capacity and processing requirements at said node.

9. A method comprising:
receiving at a plurality of nodes a multicast message that is transmitted by a node N, wherein said node N and said plurality of nodes belong to an ad-hoc wireless network, and wherein said multicast message is for extending a route that includes said node N;
transmitting from each of said plurality of nodes, in response to said multicast message, a respective message after a respective delay, wherein the contents of said respective message comprises a respective route that appends the corresponding node to the end of said route R, and wherein the length of said respective delay is based on the value of a load metric at the corresponding node and is independent of any other nodes in said ad-hoc wireless network.

10. The method of claim 9 further comprising:
receiving at least one of said respective messages at a node D in said ad-hoc wireless network; and
transmitting a reply message from said node D in response to the first respective message received at said node D.

11. The method of claim 10 wherein said reply message comprises a route from said node N to said node D.

12. The method of claim 9 wherein said load metric at a node is based on the depth of a transmission buffer at said node over a time interval.

13. The method of claim 9 wherein said load metric at a node is based on the number of current routes in said network that include said node.

14. The method of claim 9 wherein said load metric at a node is based on the processing capacity and processing requirements at said node.

15. A method comprising:
receiving at a first node in a network a first message, wherein said first message is in accordance with a load-balancing routing protocol and comprises a route R; and
transmitting from said first node, after a first delay following the reception of said first message, a second message;
wherein said second message is in accordance with said load-balancing routing protocol; and
wherein said second message comprises a route R′; and
wherein said route R′consists of said route R and said first node appended after said route R; and
wherein said delay increases the probability that a newly-established route will balance loads evenly across the nodes of said network.

16. The method of claim 15 wherein said load-balancing routing protocol employs a load metric, and wherein said delay is based on the value of said load metric at said first node and is independent of any other nodes in said network.

17. The method of claim 15 wherein said signal is multicast to a plurality of nodes in said ad-hoc wireless network.

18. The method of claim 15 wherein said load metric at a node is based on the depth of a transmission buffer at said node over a time interval.

19. The method of claim 15 wherein said load metric at a node is based on the number of current routes in said network that include said node.

20. The method of claim 15 wherein said load metric at a node is based on the processing capacity and processing requirements at said node.
